(19) United States
(12) Patent Application Publication
(10) Pub. No.: US 2005/0175748 A1
(43) Pub. Date: Aug. 11, 2005

(54) Antimicrobial envelopes

(76) Inventors: Henricus Matheus Wilhelmus Maria Thijssen, Houten (NL); Roy Christiaan Montijn, Amsterdam (NL); Johannes Wilhelmus Timmermans, Ede (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/516,045

(22) PCT Filed: May 30, 2003
(86) PCT No.: PCT/NL03/00409

(30) Foreign Application Priority Data
May 30, 2002 (NL) 1020716

(51) Int. Cl. A23K 1/00

(52) U.S. Cl. 426/326

(57) ABSTRACT

This invention relates to an antimicrobial substance in a covering which can be decomposed by microorganisms, e.g. of carbohydrates and/or proteins. This can particularly be used in an active package for preventing microbial decay of the packaged goods. For this purpose, such a covering is provided in or on the packaging material, causing the antimicrobial substance to be released only at the location where and the moment when there is microbial activity. Such a package is very suitable for packaging perishable foods.

The invention relates to antimicrobial envelopes. This type of envelopes is particularly usable in antimicrobial packages, which have as their general object to prolong the storage life of the packaged foods by preventing decay by microorganisms. These packages are usually called active packages because they actively affect the conditions of the packaged goods during storage and transport. Active packages can be divided into two groups, namely packages which can intercept gases and/or components such as oxygen and ethylene and packages which can release substances such as antioxidants, and aromatic substances and flavorings. The second group also includes the packages which can inhibit the growth of microorganisms by releasing an antimicrobial substance or by direct contact with the foods. Examples of antimicrobial substances used in packages are nisin, ethanol, metal salts and different acids. These components are mixed into a polymer matrix and used in packages as laminate or coating.

An example of such a package is described in the U.S. patent specification U.S. Pat. No. 6,264,936. In this patent, as a basis for the package, a polymer is used (e.g. a polyhexamethylene biguanide crosslinked with N,N-bismethylene diglycidylaniline) to which silver iodide is added. The U.S. patent specification U.S. Pat. No. 5,451,369 describes how nisin can be adsorbed to a polymeric packaging material.

The use of encapsulated toxic substances is described in WO 95/17816, in which (volatile) pesticides can be incorporated into a package and are slowly released therefrom (periods of months or years). This patent also describes that the capsules can be torn open under the influence of pressure (which happens when the package is eaten away by pests).

In GB 2,198,062, a potentially antimicrobial substance is packaged in microcapsules, which are provided on the packaging material in such a manner that the capsules break open when the material is used. Here, the breaking open of the capsules takes place by exertion of a mechanical force.

However, the disadvantage of the packages described hereinabove is that the components are continuously released or are in continuous contact with the foods, also when no microorganisms are present or are released under the influence of mechanical activity. Presence of (harmful) microorganisms, however, hardly ever involves mechanical activity, so that such a package is not usable for preventing decay of foods.

The present invention now solves these problems from the state of the art.

The invention relates to an antimicrobial substance which is packaged in a covering which can be decomposed by microorganisms.

Such a decomposable covering (also called capsule) preferably consists of an envelope of carbohydrate and/or protein, with oligomeric and polymeric carbohydrates and proteins being preferred which can be used as a substrate by most microorganisms. Carbohydrates which can thus be used are, for instance, glucose, fructose, sucrose, maltose, arabinose, mannose, galactose, lactose and oligomers and polymers of these sugars, cellulose, dextrins such as maltodextrin, agarose, amylose, amylopectin and gums, e.g. guar. Proteins which can be used include albumin, ovalbumin, casein, myosin, actin, globulin, hemin, hemoglobin, myoglobin and small peptides. Preferably, oligomeric carbohydrates from DP2 on or polymeric carbohydrates from DP50 on are used. These can be naturally occurring polymers such as starch (amylose, amylopectin), cellulose and gums or derivates hereof which can be formed by phosphorylization or oxidation. Other polymers can also be used (e.g. caprolactone), which can be added for a better compatibility with the packaging material. In the case of proteins, proteins obtained from hydrolysates of vegetable or animal material can also be used.

The invention further relates to packaging material for preventing microbial decay of the packaged goods, characterized in that the material comprises an antimicrobial substance covered in a covering which can be decomposed by microorganisms.

The antimicrobial substances are provided with a covering of sugars and/or proteins and coated as capsules on the packaging material.

The packaging material is preferably made of a material already used for packaging, for instance, food. Suitable materials for this are: paraffin, polytetrafluorethylene, crosslinked or non-crosslinked polypropenes, polyethenes, polypropylenes and polyethylenes, ethylene-vinyl alcohol polymers, polyvinyl chloride, polystyrene, polycarbonates, polyesters, and polyamides. Several substances from the preceding series can be used in combination, crosslinked or not. Preferably, materials are used which can form a transparent film or foil or a coating for tin, pouche, glass, cardboard or aluminum packages. Specifically suitable for tin are epoxy phenol coatings or organosol lacquers.

The following can be used as antimicrobial substances: bacteriocins, such as nisin and pediocin; metals or derived metals, such as metal oxides, metal salts, metal complexes or alloys; antibiotics, such as penicillin, erythromycin, ampicillin, isoniazid, tetracycline, sulphonamides and chloramphenicol; vegetable toxins, such as defensins, lectins, and anti-fungal proteins; ethanol; H₂O₂-producing enzymes such as oxidases; organic acids such as propionic acid and derived propionates, sorbic acid and derived sorbates, benzoic acid and derived benzoates, lactic acid; sodium diacetate; sodium nitrite; lysozyms and antimicrobial substances from spices.

Preferably, antimicrobial substances are used which are qualified as “foodgrade”, that is, they can be consumed without any health hazard. Such antimicrobial substances can, for instance, be obtained from herbs and/or spices. Antimicrobial substances (e.g. defensins) produced by plants for defense against bacterial or fungous infections are also usable. Finally, mention should be made of the category of antimicrobial substances produced by fungi which are already being incorporated into the food (e.g. in the preparation of cheese).

The advantage of the present invention is that the antimicrobial substance will only be released at the location where microorganisms are present and active. This means that, in the absence of microorganisms, no migration of the antimicrobial substance to the environment (the packaged material, e.g. a food) will occur, and also that, in the presence of microorganisms to be controlled, the amount of released antimicrobial substance will be limited to a minimum. This allows the package to be used in particular for foods of which microbial decay is the limiting factor for the storage life of the product. These are perishable products such as meat products, cheese, bread, sauces, margarine, salads, ready-to-eat meals and the like. In addition, a package according to the invention can also be used in the packaging of food in general and also for other perishable goods, such as cosmetics (including oils, ointments and soaps), medicines, and the like.

The choice of the antimicrobial substance can depend on the material that is packaged using the package. In general, in food packaging, only those antimicrobial substances will be used which do not harm the health of the consumer of the food product. This means that for the packaging of, for instance, cosmetics, there is a wider choice of potentially usable antimicrobial substances available.

Other uses of the antimicrobial substance packaged in a covering which can be decomposed by microorganisms are possible. Such a packaged antimicrobial substance, in particular a fungicidal substance, can very well be used in fungicidal paints. The advantage compared to other fungicidal paints is that the paints according to the invention remain active much longer, since the antimicrobial substance is only released when there is reason to.

Also in therapeutic uses, coverings with an active substance according to the invention therein are usable. An example is the release of medicines in the intestines where the coverings can be decomposed by the intestinal flora present and thus effect the release of an active substance. For this use, any therapeutically active substance can be used and the invention is not limited to antimicrobial agents. Preferably, those therapeutically active substances are used that run the risk of being decomposed in the mouth, esophagus or stomach.

In addition, a packaged antimicrobial substance according to the invention can also very well be used in an anti acne gel. Here again, the advantage compared to the known anti acne agents is that the antimicrobial substance is only released at the moment and at the location where the microorganisms are present. This prevents undesired exposure of the skin to the antimicrobial agent. In addition to use in anti acne agents, the packaged antimicrobial substance according to the invention can also be used in other cosmetics. This is because it is known that cosmetics applied on the skin (e.g. creams, lotions, powders, and the like) are a food source for microorganisms. So, infections of microorganisms which use these applied cosmetics as a food source can be prevented by the invention. Thus, the invention also makes it possible for antimicrobial agents used in the current cosmetics (e.g. alcohol or alcohol derivates) to be left out of the cosmetics composition. This is especially advantageous because these agents often cause irritation of the skin. This skin irritation is absent if the antimicrobial substance according to the invention is used.

Another application is the use of the antimicrobial substance packaged according to the invention in dressing means, such as dressings for wounds, but also sanitary dressings. In wound healing, control of microorganisms is a prerequisite and a dressing according to the invention contributes to the antimicrobial substance being released only at locations where this is needed, and needless exposure of wound tissue to antimicrobial agents being prevented.

In addition, a coating with an antimicrobial substance packaged according to the invention can very well be used in vulnerable systems. In this context, vulnerable systems are systems (materials, humid environments) susceptible to infection by microorganisms, such as (the cut stems of) cut flowers, plant roots, nutrient media of rock wool or other material, etc. Coating this type of materials using a coating according to the invention does not hinder the functions (e.g. water or nutrient intake) of the materials, but still provides a sufficient protection against microorganisms.

Finally, a coating according to the invention could also very well be used on surfaces which often come into contact with foods and can, in this manner, be a source of contamination. Examples of these are chopping boards for cutting meat, vegetables and the like, work tops or other surfaces on which foods are prepared or put aside, conveyor belts in industrial food preparation and processing, and storage means (racks, crates and the like) where foods are stored without protection. Here, care must be taken that the coverings do not break due to mechanical force or friction. Also, to guarantee sufficient antimicrobial capacity, the coatings have to be applied again after a certain period of time. To determine this moment, the coating can simply be tested by applying a microorganism thereon on purpose and seeing if the coating still contains sufficient packaged antimicrobial agent to stop the growth of the microorganism.

### EXAMPLES

### Example 1: Synthesis of gel A

A solution of 54 mg of NaOH in 90 ml of water was brought to a temperature of 0° C. To this, 600 μl of divinyl sulphone (DVS) were added. Then, C6-oxidized starch having a degree of oxidation (DO) of more than 90% was added slowly with vigorous stirring. The solution changed overnight into a soft and virtually colorless transparent gel. This gel was pressed through a sieve with meshes of approximately 1 mm², after which 1 liter of water was stirred through the gel, which water was absorbed directly. After this, the gel was precipitated using 2 liters of ethanol and was then washed twice using ethanol and once using acetone, after which the gel was air-dried. This resulted in 12.1 grams of gel having a free swelling (net weight divided by dry weight) of 59 in water.

### Example 2: Synthesis of gel B

Synthesis and further processing as gel A, but using C6-oxidized starch having a DO of 50% instead of more than 90%. This resulted in 9.78 g of gel having a free swelling of 51 in water.

### Example 3: Synthesis of gel C

To 89 ml of ice water, 1.00 ml of a NaOH solution, obtained by dissolving 539 mg of NaOH with 10.1 ml of water, was added. To this, 800 μl of DVS were added. Then, 10 grams of C6-oxidized starch (DO 30%) were added slowly with vigorous stirring. The solution changed overnight into a hard and virtually colorless transparent gel. This gel was pressed through a sieve with meshes of approximately 1 mm², after which 0.5 liter of water was stirred through the gel, which water was absorbed directly. After this, the gel was precipitated using 1 liter of ethanol, and then washed twice using ethanol and once using acetone, after which the gel was air-dried. This resulted in 9.02 grams of gel having a free swelling (net weight divided by dry weight) of 49 in water.

### Example 4: Synthesis of gel D

To a solution of 58 mg of NaOH in 90 ml of ice water, 600 μl of DVS were added. Fifteen grams of C6-oxidized starch (DO 30%) were added slowly with vigorous stirring. The solution changed overnight into a hard and virtually colorless transparent gel. This gel was pressed through a sieve with meshes of approximately 1 mm², after which 0.5 liter of water was stirred through the gel, which water was absorbed directly. After this, the gel was precipitated using 1 liter of ethanol, and then washed twice using ethanol and once using acetone, after which the gel was air-dried. This resulted in 13.4 grams of gel having a free swelling of 51 in water.

### Example 5: Synthesis of gel E

A solution of 58 mg of NaOH in 90 ml of water was cooled to a temperature of 0° C. To this, 400 μl of DVS were added. Directly after this, a mixture of 10.0 grams of paselli 2 and 5.0 grams of the Na salt of carboxymethyl cellulose (having a low viscosity) were added with vigorous stirring. The solution changed overnight into a soft, milk white gel. This gel was pressed through a sieve with meshes of approximately 1 mm², after which 0.5 liter of water was stirred through the gel, which water was absorbed directly. After this, the gel was precipitated using 1 liter of ethanol, and then washed twice using ethanol and once using acetone, after which the gel was air-dried. This resulted in 9.66 grams of gel having a free swelling of 31 in water.

### Example 6: Susceptibility of the different gels to α-amylase

To 10 ml of water, 50-100 mg of gel were added, after which it was stirred at 37° C. Then, 100 μl of a-amylase were added (Termamyl, Novo Nordisk). The gels C, D and E were found to be dissolved after 1 hour. Gel B was only dissolved after one night and gel A was still not noticeably affected after two days.

### Example 7: Incorporating Lysozyme into gel E and release under the influence of α-amylase

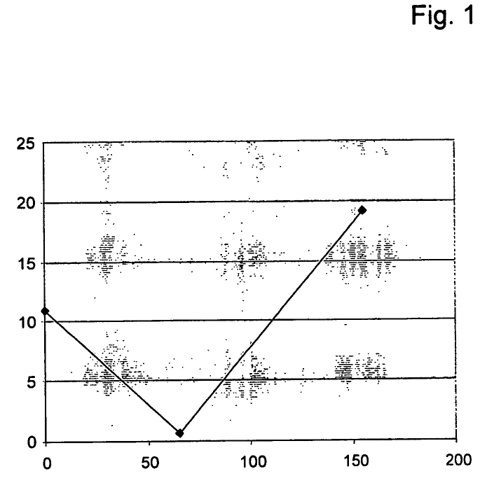

To a solution of 105 mg of lysozyme in 10 ml of water, 180 mg of gel E were added. After stirring for 10 minutes at room temperature, the gel was washed 6 times using approximately 50 ml of ice water. Each time, the gel was isolated by means of centrifuging (4700 rpm). This resulted in 6.5 grams of gel. Of this gel, 2.9 grams were added to 15 ml of water. Then, it was stirred for 10 minutes at room temperature and for 20 minutes at 37° C. After this, 100 μl of α-amylase were added (Termamyl, Novo Nordisk), after which it was stirred for 1 hour at 37° C. By means of a 0.45-μm filter, a sample was taken for analysis of the solution resulting after deposition of the gel particles 5 minutes after the dry gel was added to the lysozyme solution, 5 minutes after the washed gel containing lysozyme was added to water and after an hour of action of α-amylase. The concentration of lysozyme was determined by measuring the decrease in OD (optical density) in a Micrococcus suspension. The part of the enzyme present which was in solution was found to be, for above samples, 11%, 0.7% and 19% respectively. This is shown in FIG. 1. This means that 89% of the lysozyme was incorporated into the gel by adding the dry gel to a lysozyme solution and that, after the action of a-amylase, the lysozyme concentration had increased by a factor 27.

### Example 8: Incorporating Lysozyme into gel C and release under the influence of α-amylase

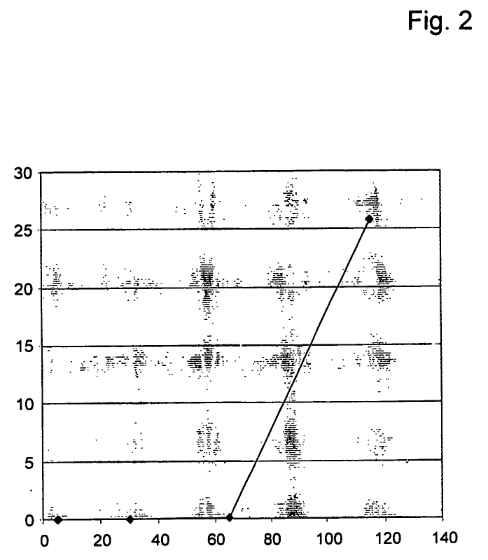

To a solution of 122 mg of lysozyme in 12 ml of water, 196 ml of gel C were added. After stirring for 5 minutes at room temperature and stirring for 8 minutes at 37° C., the gel was cooled to 0° C., after which the gel was washed 8 times using ice water. This resulted in 6.5 grams of gel. Of this, 4.3 grams were added to 10 ml of water. After stirring for 30 minutes at room temperature and for 35 minutes at 37° C., 100 μl of α-amylase were added (Termamyl, Novo Nordisk), after which it was stirred for 50 minutes at 37° C. After 5, 30, 65 and 115 minutes, a sample was taken for analysis. The part of the lysozyme present that was in solution (in %) is plotted in FIG. 2 as a function of time in minutes. It was found that, after adding gel C, only 0.01% of the lysozyme used was free in solution. After stirring for 30 minutes at room temperature, this was 0.04%, and after again stirring for 35 minutes at 37° C., this was 0.06%. Addition of α-amylase resulted in an increase by a factor 425 in 50 minutes, causing the lysozyme activity to increase to 26% of the amount that was present in the gel.

### Example 9: Incorporating Lysozyme into gel C and release under the influence of α-amylase

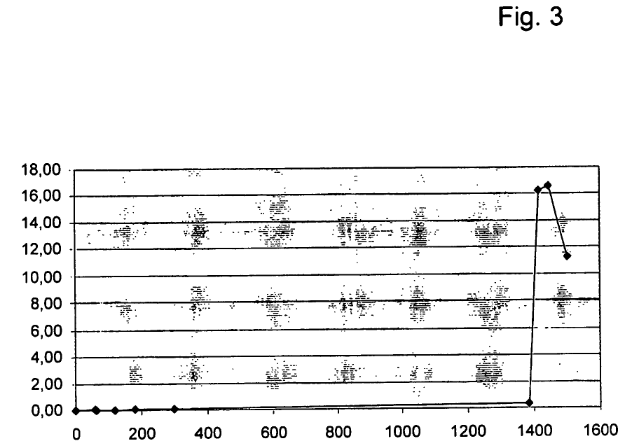

To a solution of 130 ml of lysozyme in 30 ml of water, 205 mg of gel C were added. After stirring for 10 minutes at room temperature, taking a sample of the solution, and then cooling to 0° C., the gel was washed 8 times using approximately 50 ml of ice water. This resulted in 7.3 grams of gel. Of this, 3.3 grams were added to 15 ml of water, after which it was stirred at room temperature. After 10 minutes, 1 hour, 2 hours, 4 hours and overnight (a total of 1385 minutes), a sample was taken for analysis. Then, 100 μl of α-amylase were added (Termamyl, Novo Nordisk), after which it was stirred for 2 hours at room temperature. After 30, 60 and 120 minutes, a sample was taken for analysis. The part of the lysozyme present that was free in solution (in %) is shown in FIG. 3 as a function of time. It was found that, 10 minutes after adding the dry gel to the lysozyme solution, only 0.01% of the enzyme was free in solution. Also, 5 minutes after the wet and washed gel was added to water, only 0.01% of the lysozyme was not bound to the gel. After stirring for 4 hours at room temperature, this became 0.1%, and after stirring for a whole night at room temperature, this became 0.5%. Only half an hour after adding the α-amylase, the lysozyme activity was found to increase 40 times. That is 16% of what was present in the gel.

### Example 10: Incorporating Lysozyme for testing purposes

To a solution of 170 mg of lysozyme in 15 ml of water, 203 mg of gel C were added. After stirring for 5 minutes at room temperature, the gel was washed 6 times using approximately 50 ml of ice water. Each time, the gel was isolated by means of centrifuging (4700 rpm). This resulted in 5.1 grams of gel.

### Example 11: Synthesis of a protein/carbohydrate envelope

To 80 grams of water, 10 g of NaCl, 13 grams of maltodextrin (Paselli SA2) and 5 grams of casein were added. This mixture was stirred and results in a dispersion which was then added to a mixture of 110 grams of paraffin oil and 7 grams of Tween 85. The emulsion was mixed using an ultra turrax at 22° C. After this, 0.21 g of NaOH and 1.2 ml of epichlorohydrin in 2 ml of water were added to the emulsion. Then, it was again stirred using the ultra turrax and the temperature was increased to 50° C. During the reaction (5 hours), the emulsion was now and then stirred using top agitator and ultra turrax. The envelopes were isolated by first initiating a phase separation by adding 0.52 ml of 37% HCl in 50 ml of water to the emulsion. Then, the temperature was decreased to 21° C. and the envelopes were isolated by adding ethanol until a concentration of 50% was reached. The precipitate was filtered over a G3 glass filter. After this, the residue was incorporated into 100 ml of water and again precipitated using 150 ml of 100% ethanol. After the precipitate was isolated by filtration over a G3 glass filter, it was washed one more time using 500 ml of 100% ethanol, and then the envelopes were air-dried.

### Example 12: Effectiveness against tester strain

To test the effectiveness of the polymer matrix in which an antimicrobial compound is contained, a suspension of this matrix was dripped on an agar plate in which the tester strain is enclosed. By incubating the plate at 25° C., the tester strain will grow, except on the spot where the envelopes are being decomposed by microbial activity of the tester strain itself (amylase secretion). A successful inhibition of the microbial activity becomes manifest in the form of a clear ring (halo) around the spot where the envelopes were dripped on the plate.

Material and Method

Test strain

| Name | Culture collection no. | Medium | Temp. |
|---|---|---|---|
| Bacillus licheniformis | LMG 7558 | yeast-starch | 25° C. |
| | | agar | |

The strain was grown on starch yeast extract agar and standardized to OD_{650 nm}0.5 using PPS. This is the graft suspension. Of this, a 10⁻¹ through 10⁻⁴ dilution was made. Before casting the plates (Ø15 cm, 50 ml of agar per plate), to the yeast-starch agar medium (nutrient agar+0.05% yeast extract+2% starch), per 100 ml, 1 ml of culture was added in the dilution of 10⁻² per 100 ml (concentration in the agar 10⁴ kve/ml). Per plate, 1 ml of test substance (100%, 90%, 80%, 70%, 60% and 50% respectively, suspension of starch globules with lysozyme in aqua dest.) was added and the plate was dried for 30 minutes. Then, the plates were incubated at 25° C. The halo formation was judged with the eye and photographed. All plates grafted using test substance showed a clear halo, from which it may be concluded that the antimicrobial substance has been released.

Legend to the Figures:

FIG. 1: Gel E. Percentage of free lysozyme (%) as a function of time (minutes).

FIG. 2: Gel C. Percentage of free lysozyme (%) as a function of time (minutes).

FIG. 3: Gel C. Percentage of free lysozyme (%) as a function of time (minutes).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A packaging material for preventing microbial decay of packaged goods, characterized in that the material comprises an antimicrobial substance having a covering which can be decomposed by microorganisms.

16. A packaging material according to claim 15, characterized in that the covering is formed by carbohydrates and/or proteins which can be decomposed by microorganisms.

17. A packaging material according to claim 16, characterized in that the carbohydrates are polymeric carbohydrates.

18. A packaging material according to claim 15, characterized in that the material forms a transparent film, foil or coating.

19. A packaging material according to claim 18, characterized in that the material consists of a substance selected from the group of polypropylene, polyethene, polyethene terephtalate, polyvinyl chloride and polyvinylidene dichloride.

20. A packaging material according to claim 15, characterized in that the coverings are coated on the material.

21. A method for manufacturing packaging material according to claim 15, characterized in that the coverings of carbohydrate and/or protein containing an antimicrobial substance are coated on the material.

22. A food product packaged using a packaging material according to claim 15.

23. A packaging material according to claim 16, characterized in that the material forms a transparent film, foil or coating.

24. A packaging material according to claim 17, characterized in that the material forms a transparent film, foil or coating.

25. A packaging material according to claim 23, characterized in that the material consists of a substance selected from the group of polypropylene, polyethene, polyethene terephtalate, polyvinyl chloride and polyvinylidene dichloride.

26. A packaging material according to claim 24, characterized in that the material consists of a substance selected from the group of polypropylene, polyethene, polyethene terephtalate, polyvinyl chloride and polyvinylidene dichloride.

27. A packaging material according to claim 17, characterized in that the coverings are coated on the material.

28. A packaging material according to claim 18, characterized in that the coverings are coated on the material.

29. A packaging material according to claim 24, characterized in that the coverings are coated on the material.

30. A packaging material according to claim 19, characterized in that the coverings are coated on the material.

31. A packaging material according to claim 26, characterized in that the coverings are coated on the material.

32. A method for manufacturing packaging material according to claim 17, characterized in that the coverings of carbohydrate and/or protein containing an antimicrobial substance are coated on the material.

33. A method for manufacturing packaging material according to claim 18, characterized in that the coverings of carbohydrate and/or protein containing an antimicrobial substance are coated on the material.

34. A method for manufacturing packaging material according to claim 19, characterized in that the coverings of carbohydrate and/or protein containing an antimicrobial substance are coated on the material.

35. A method for manufacturing packaging material according to claim 20, characterized in that the coverings of carbohydrate and/or protein containing an antimicrobial substance are coated on the material.

36. A food product packaged using a packaging material according to claim 17.

37. A food product packaged using a packaging material according to claim 18.

38. A food product packaged using a packaging material according to claim 19.

39. A food product packaged using a packaging material according to claim 20.
